(19) United States
(12) Patent Application Publication
(10) Pub. No.: US 2014/0280102 A1
(43) Pub. Date: Sep. 18, 2014

(54) MOVING SERVICES MOBILE APPLICATION AND SYSTEM

(71) Applicant: Randal Viggiani, Lakeland, FL (US)

(72) Inventor: Randal Viggiani, Lakeland, FL (US)

(21) Appl. No.: 13/842,780

(22) Filed: Mar. 15, 2013

(51) Int. Cl. G06F 17/30

(52) U.S. Cl. CPC G06F 17/3087; G06F 17/30424
USPC 707/724; 707/758

(57) ABSTRACT

Some implementations can include a method comprising obtaining moving company information and verifying moving company information. The method can also include adding moving company information to a database and providing moving company information in response to a database query. The moving company information can be provided to a mobile device.

### FIELD

Embodiments relate generally to mobile application software and more particularly to mobile application software for matching moving service customers with moving service companies.

### SUMMARY

Some implementations can include a method comprising obtaining moving company information and verifying moving company information. The method can also include adding moving company information to a database and providing moving company information in response to a database query. The moving company information can be provided to a mobile device.

Some implementations can include a method comprising obtaining a location and obtaining a radius. The method can also include querying a database using the location and the radius. The method can further include providing, for display on a mobile device, a result list of verified moving companies, the result list based on the querying. The method can also include providing a coupon for one or more moving companies on the result list. The method can further include causing a user interface to be displayed, the user interface being configured to permit a user to contact a moving company on the result list.

Some implementations can include a system having one or more processors configured to perform operations. The operations can include obtaining moving company information and verifying moving company information. The operations can also include adding moving company information to a database. The operations can further include providing moving company information in response to a database query and obtaining a location. The operations can also include obtaining a radius and querying a database using the location and the radius. The operations can further include providing, for display on a mobile device, a result list of verified moving companies, the result list based on the querying. The operations can also include providing a coupon for one or more moving companies on the result list. The operations can also include causing a user interface to be displayed, the user interface being configured to permit a user to contact a moving company on the result list.

### BRIEF DESCRIPTION

FIG. 1 is a diagram of a mobile application system in accordance with at least one embodiment.

FIG. 2 is a flowchart showing a method of adding a moving company to a mobile application database in accordance with at least one embodiment.

FIG. 3 is a flowchart showing an example method for matching a moving service company with a moving service customer in accordance with at least one embodiment.

FIG. 4 is a diagram of a server system in accordance with at least one embodiment.

FIG. 5 is a diagram of an example user interface for a moving service mobile application in accordance with at least one embodiment.

FIG. 6 is an example user interface for a moving service customer in accordance with at least one embodiment.

FIG. 7 is an example user interface showing results of a moving service matching in accordance with at least one embodiment.

FIG. 8 is an example user interface showing a selected moving company and providing methods of contacting the moving company in accordance with at least one embodiment.

### DETAILED DESCRIPTION

FIG. 1 shows a moving mobile application environment 100 having a moving mobile application system 102 that includes a server device 104 and a moving mobile application database 106. Also shown are mover client devices 108 and 110. FIG. 1 also shows a moving company client device 112. Client devices 108-112 are coupled to the moving mobile application system 102 via a network 116. The network 116 includes any wired or wireless networks now known or later developed.

In operation a moving company accesses the moving company mobile application system 102 via moving company client device 112. The moving company can establish itself with the moving mobile application system 102 by providing information and becoming a registered provider within the moving mobile application system 102. Details of adding a moving company to the system are described below in connection with FIG. 2.

When a mover wishes to identify a moving company, the mover can access the moving mobile application system through the mover client device 108 or 110. The client device has access to the moving mobile application system to query the moving mobile application database 106 to identify a moving company that meets the search or query parameters provided to the moving mobile application system 102. Results of the query are provided to the client devices 108 or 110 via network 116.

FIG. 2 shows an example method of adding a moving company to the moving mobile application system. At 202, the system receives information from a moving company seeking to be added to the system.

At 204, the information provided by the moving company is verified. The verification can include verifying moving company name, address, business status, reputation with business reputation services (e.g., Better Business Bureau or the like), and moving company insurance information.

At 206, verified moving companies are added to the database.

At 208, moving company information stored in the database is provided to users in response to search queries in which the moving company information matches or is close to the search query being performed by the user.

FIG. 3 shows a flowchart of an example method for searching a moving company mobile application database.

At 302, the system obtains a location of the move. For example, a user can interpret a zip code or an address or the like to identify location from where a move is taking place.

At 304, the system obtains a radius for which companies within that radius are to be provided to the user. For example, a user may wish to see companies within a 10-mile radius of the location provided in 302.

At 306, the moving company application database is queried using the location and radius provided in 302 and 304 respectively.

At 308, a system provides a list of results of moving companies matching or close to the query submitted in 306.

At 310, a coupon is provided for a selected company from the result list.

At 312, an interface is caused to be displayed that provides detailed information for contacting a selected moving company. For example, the user interface can include the moving company name, address, telephone number, email and website address. The interface can also include buttons for accessing the company directly via telephone, text message (e.g., SMS or short message service) or email.

FIG. 4 is a diagram of an example server device 400 that can be used for a moving service mobile application in accordance with some implementations. The server device 400 includes a processor 402, operating system 404, memory 406 and I/O interface 408. The memory 406 can include a mobile application engine 410 and moving company application 412.

In operation, the processor 402 may execute the moving company application 410 stored in the memory 406. The moving company application 410 can also operate in conjunction with the operating system 404.

FIG. 5 shows an example user interface screen for moving mobile application software being executed on a mobile device. The user interface 500 includes a first element for selection by movers 502 and a second selection for moving companies 504.

FIG. 6 shows an example screen 600 for entering location and radius information for a search. In particular the user interface 600 includes an element for entering location 602, an element for entering radius 604, a selection for choosing movers set for long-distance providers only 606, a search button 608 and a cancel button 610.

FIG. 7 shows an example user interface 700 that provides results of a query to the moving application database. In particular the user interface 700 includes a location element 702, a radius element 704, a search button 706, a long-distance providers only element 708, a list of results 710, and ratings associated with each result 712 in distances of the company from the location entered by the user 714.

FIG. 8 shows an example user interface screen 800 providing details of a particular company that was selected by the user. In particular, the user interface screen 800 includes a location element 802, a radius element 804, a search element 806, a long-distance providers only element 808, moving company detail element 810, a call button 812, an SMS button 814, an email button 816, and a review button 818.

The server (e.g., 102 and/or 400) can include, but is not limited to, a single processor system, a multi-processor system (co-located or distributed), a cloud computing system, or a combination of the above.

The client device can include, but is not limited to, a desktop computer, a laptop computer, a portable computer, a tablet computing device, a smartphone, a feature phone, a personal digital assistant, a media player, an electronic book reader, an entertainment system of a vehicle or the like.

The network connecting user devices to a mobile application server can be a wired or wireless network, and can include, but is not limited to, a WiFi network, a local area network, a wide area network, the Internet, or a combination of the above.

The data storage, memory and/or computer readable medium can be a magnetic storage device (hard disk drive or the like), optical storage device (CD, DVD or the like), electronic storage device (RAM, ROM, flash, or the like). The software instructions can also be contained in, and provided as, an electronic signal, for example in the form of software as a service (SaaS) delivered from a server (e.g., a distributed system and/or a cloud computing system).

Moreover, some implementations of the disclosed method, system, and computer readable media can be implemented in software (e.g., as a computer program product and/or computer readable media having stored instructions for performing notifications across different devices as described herein). The stored software instructions can be executed on a programmed general purpose computer, a special purpose computer, a microprocessor, or the like.

It is, therefore, apparent that there is provided, in accordance with the various example implementations disclosed herein, systems, methods and computer readable media for moving services mobile applications.

While the disclosed subject matter has been described in conjunction with a number of implementations, it is evident that many alternatives, modifications and variations would be or are apparent to those of ordinary skill in the applicable arts. Accordingly, Applicant intends to embrace all such alternatives, modifications, equivalents and variations that are within the spirit and scope of the disclosed subject matter.

What is claimed is:

1. A method comprising:
obtaining moving company information;
verifying moving company information;
adding moving company information to a database; and
providing moving company information in response to a database query.

2. The method of claim 1, wherein the moving company information is provided to a mobile device.

3. A method comprising:
obtaining a location;
obtaining a radius;
querying a database using the location and the radius;
providing, for display on a mobile device, a result list of verified moving companies, the result list based on the querying;
providing a coupon for one or more moving companies on the result list; and
causing a user interface to be displayed, the user interface being configured to permit a user to contact a moving company on the result list.

4. A system having one or more processors configured to perform operations comprising:
obtaining moving company information;
verifying moving company information;
adding moving company information to a database;
providing moving company information in response to a database query;
obtaining a location;
obtaining a radius;
querying a database using the location and the radius;
providing, for display on a mobile device, a result list of verified moving companies, the result list based on the querying;
providing a coupon for one or more moving companies on the result list; and
causing a user interface to be displayed, the user interface being configured to permit a user to contact a moving company on the result list.
